(19) United States
(12) Patent Application Publication
(10) Pub. No.: US 2006/0235834 A1
(43) Pub. Date: Oct. 19, 2006

(54) Path expression in structured query language

(75) Inventors: Jose A. Blakeley, Redmond, WA (US); Evgueni Zabokritski, Redmond, WA (US); Conor Cunningham, Redmond, WA (US); Balaji Rathakrishnan, Sammamish, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/105,878

(22) Filed: Apr. 14, 2005

(51) Int. Cl. G06F 17/30

(52) U.S. Cl. 707/4

(57) ABSTRACT

Systems and methods for extension of a query language for defining a simple formulation of joins by capturing the semantics of an existing linkage between a plurality of tables, via employing a reference join. Such reference join enables a compiler to exploit existing relationships in a data base, and employ existing knowledge about referential constraints for an unambiguous transformation of the reference join expression into the equivalent INNER JOIN on the columns involved. Accordingly, a simpler query syntax and semantics can be provided to express multi-table join navigation over primary key/foreign key relations, for example.

### TECHNICAL FIELD

The subject invention relates generally to query languages, and in particular to formulation of joins that exploit existing relationships in a database.

### BACKGROUND OF THE INVENTION

Increasing advances in computer technology (e.g., microprocessor speed, memory capacity, data transfer bandwidth, software functionality, and the like) have generally contributed to enhanced computer application in various industries. Ever more powerful server systems, which are often configured as an array of servers, are commonly provided to service requests originating from external sources such as the World Wide Web, for example.

As the amount of available electronic data grows, it becomes more important to store such data in a manageable manner that facilitates user friendly and quick data searches and retrieval. A DataBase Management System (DBMS) can typically manage any form of data including text, images, sound and video. Today, a common approach is to store electronic data in one or more databases. In general, a typical database can be referred to as an organized collection of information with data structured such that a computer program can quickly search and select desired pieces of data, for example. Commonly, data within a database is organized via one or more tables. Such tables are arranged as an array of rows and columns. In accordance thereto, database and file structures are determined by the software application.

Also, the tables can comprise a set of records, and a record includes a set of fields. Records are commonly indexed as rows within a table and the record fields are typically indexed as columns, such that a row/column pair of indices can reference a particular datum within a table. For example, a row can store a complete data record relating to a sales transaction, a person, or a project. Likewise, columns of the table can define discrete portions of the rows that have the same general data format, wherein the columns can define fields of the records.

Queries for such tables can be constructed in accordance to a standard query language (e.g., structured query language (SQL)) in order to access content of a table in the database. Likewise, data can be input (e.g., imported) into the table via an external source. Moreover, Database application designers can typically model the world using data modeling languages, such as the Entity Relationship Model, and the Unified Data Model Language (UML), for example.

Such models can represent the world in terms of entities and relationships. For example, in a database that holds data relating to Authors and Documents, the document and author can be treated as entities, and “WrittenBy” can be designated as a relationship. A relationship definition commonly can have a cardinality associated therewith. As such, in a database environment there can exist one-to-one (1:1), one-to-many (1:N), and many-to-many (N:M) relationships (where N and M are integers).

One-to-one and one-to-many relationships can be captured in SQL through referential constraints. Likewise, many-to-many relationships can typically be modeled by introducing an intermediate table (e.g., WrittenBy) that captures such relationship. Typically, semantics of the SQL query and update statements is firmly rooted in the relational algebra. Nonetheless, today various SQL queries that navigate multiple tables through joins are typically too verbose in their formulation.

For example, in a many to many relationship between a table of authors and documents, wherein a document can have many authors and an author may have written many documents, first the relationships between the tables is required to be spelled out. Subsequently, the join conditions need to be specified and various filter expressions applied. Accordingly, formulating such queries can require employing a plurality of tables and at the level of SQL, all details related to such connection should typically be spelled out. Accordingly, a plurality of definitions need to be designated that can further lead to verbose formulations, which result in a cumbersome interface for application developers and a waste of system resources.

Therefore, there is a need to overcome the aforementioned exemplary deficiencies associated with conventional systems and devices.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

The subject invention provides for systems and methods that can extend a query language and define a simple formulation of joins by capturing the semantics of an existing linkage among a plurality of tables, via employing a reference join. Such reference join (REF JOIN) can exploit existing relationships in a data base (e.g., primary key-foreign key relationships captured in relational metadata) to formulate a syntactic simplicity. To supply a ref join in accordance with the invention between two source tables (e.g., a left_table_source {LTS} and a right_table_source {RTS}), in general only one referential constraint should exist therebetween.

For example, when a SQL compiler can unambiguously map succinct notation implemented by the reference join, wherein typically only one path exists among relationships. In other cases, a user can be prompted to provide additional information for uniquely defining such a single path. Thus, a SQL compiler in accordance with an aspect of the subject invention can employ existing knowledge about referential constraints to enable an unambiguous transformation of the reference join (REF JOIN) expression into the equivalent INNER JOIN on the columns, which participate in the referential constraints between the two tables. Accordingly, a simpler query syntax and semantics can be provided to express multi-table join navigation over primary key/foreign key relation(s), for example.

In a further aspect, reference joins of the subject invention can be transformed to inner joins, wherein if there is an unambiguous referential integrity constraint path between a plurality of tables, some tables can remain unexposed to provide for table “hops” during navigation. For example, once there is an unambiguous referential integrity constraint path between Table 1 (T1) and Table 2 (T2) via Table 3 (T3), then T1 REF JOIN T2 can translate into T1 INNER JOIN T3 INNER JOIN T2, without exposing columns of T3.

In a further aspect of the subject invention, users can reference document views to obtain required values, wherein during an update the reference joins can facilitate automatic transformation of corresponding primitive updates on the underlying base tables, and execute the base table update in proper order to satisfy referential integrity constraints. Accordingly, reference joins (REF JOINs) of the subject invention can facilitate an automatic translation of insert, delete, and updates of object views as defined by the REF JOINs. Such automatic translation into the corresponding proper and ordered sequence of equivalent base table updates is typically performed by respecting the referential integrity constraints, which are defined among the underlying base tables that contribute to the document views.

According to a further aspect of the subject invention, a relational join component can be provided that dynamically learns the various relationships created—(as compared to the static existing foreign key (FK)-primary key (PK) relationship)—so as the database grows, such relation join can guide the compiler to spell out the reference join. In addition, the subject invention can facilitate mapping to the relational model by object relational system(s).

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings.

### BRIEF DESCRIPTION OF THE DRAWINGS

FIG. 1 illustrates a block diagram of a reference join system in accordance with an aspect of the subject invention.

FIG. 2 illustrates a particular example of a reference join operation among a plurality of tables in accordance with an aspect of the subject invention.

FIG. 3 illustrates a block diagram of a Query Compilation Pipeline that can implement various aspects of the subject invention.

FIG. 4 illustrates an exemplary flow of simplifying a formulation of joins via a reference join in accordance with an aspect of the subject invention.

FIG. 5 illustrates an exemplary methodology of view update with reference joins, according to a particular aspect of the invention.

FIG. 6 illustrates a block diagram of a relational join that can dynamically learn the linkage constrains among tables as the database grows, according to the subject invention.

FIG. 7 illustrates a block diagram of a client server that can employ reference joins in accordance with an aspect of the subject invention.

FIG. 8 illustrates a brief general description of a suitable computing environment wherein the various aspects of the subject invention can be implemented.

FIG. 9 illustrates a schematic diagram of a client-server system that can employ a reference join according to one aspect of the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

As used in this application, the terms “component,” “handler,” “model,” “system,” and the like are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the Internet with other systems via the signal).

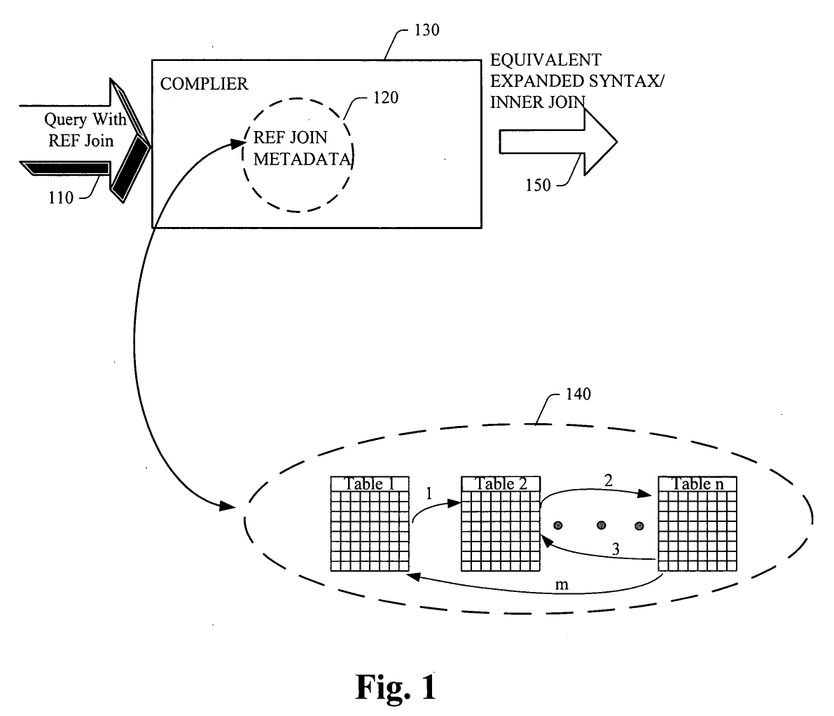

The subject invention provides for systems and methods that can extend a query language and define a simple formulation of joins by capturing the semantics of an existing linkage between a plurality of tables, via employing a reference join. Referring initially to FIG. 1, there is illustrated a query statement 110 that includes a reference join (REF JOIIN) clause being forwarded to a compiler 130 for transformation to an equivalent expanded syntax using explicit JOIN clauses, in accordance with an aspect of the subject invention. Such query statement 110 with reference join can exploit the knowledge of existing relationships in a data base to afford the user who writes the query statement, a syntactic simplicity for queries that traverse relationships. The existing relationships can be in form of a primary key (PK)-foreign key (FK), wherein the foreign key can be a column or combination of columns used to establish and enforce a link between the data of a source table and a target table, for example.

Accordingly, the link can be created between the source table and the target table by adding to the target table the column or columns in the source table that hold primary key values. Such column(s) can then become a foreign key in the target table. Upon receiving the query 110 with REF JOIN the compiler 130 can exploit the available knowledge currently existing among various entities in a database (e.g., reference join metadata 120) to transform such succinct notation to a more detailed version 150. For example, by exploiting the already existing relationships in the relational domain 140 (e.g., employing relationship elements in the Relational Schema Definition, and/or tables 1 to n, where n is an integer) the compiler 130 can supply unambiguous transformation for a unique navigation path 1 to m, (where m is an integer). As such, to supply a reference join in accordance with the invention, the compiler 130 should in general unambiguously map succinct notation implemented by the reference join. Accordingly, a simpler query syntax and semantics can be provided to express multi-table join navigation over primary key/foreign key, for example.

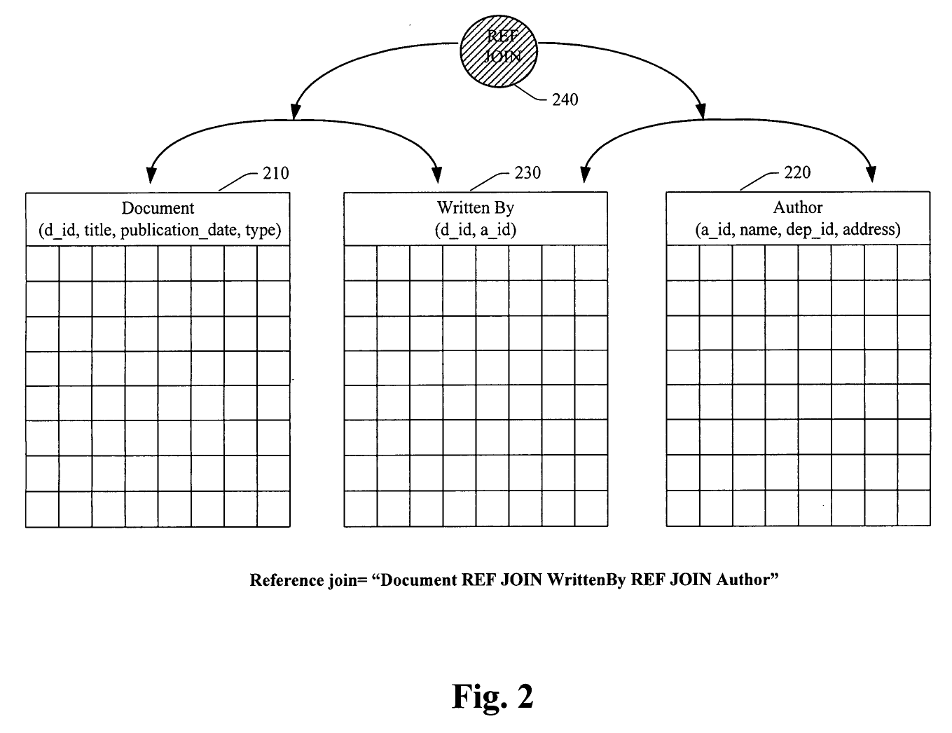

FIG. 2 illustrates the implementation of the reference join for a particular example in accordance with an aspect of the subject invention. As illustrated table 210, table 220, and table 230 respectively tabulate: “Document”, “Author”, and “Written by” in a many-to-many relationship that exists among them. The following schema can describe the existing relation:

Table: Author ( a_id, name, dep_id, address)
Table: WrittenBy ( d_id, a_id )
Type: Address ( street_no, city, state, zipcode )

An exemplary query to retrieve the names of Washington state authors who have a document published in 2003, without employing a reference join of the subject invention can be written as:

SELECT a.name
FROM Author a INNER JOIN WrittenBy da ON a.a_id =
da.a_id

INNER JOIN Document d ON d.d_id =da.d_id

WHERE a.address.state = ‘WA’ AND
d.publication_date.year = 2003

In the example above, Document and Author are entities, while WrittenBy is a relationship. Typically, such a relationship definition has a cardinality associated therewith. It is to be appreciated that the above example is for illustrative purposes, and there can exist one-to-one (1:1), one-to-many (1:N), and many-to-many (N:M) relationships (N and M being integers), wherein such relationships can be typically captured in SQL through referential constraints, and many-to-many relationships are commonly modeled by introducing an intermediate table 230 (e.g., WrittenBy) that can capture the relationship.

By employing a reference join 240 as an SQL query extension in accordance with the subject invention, a simplified syntax can be supplied that enables navigation of joins over columns that represent referential constraints. Accordingly, and assuming the system has captured the notion that WrittenBy is an N:M relationship between Document and Author, the subject invention can provide a re-write of the query in a more compact form, via employing the reference join 240, for example in form of the following syntax:

SELECT name

FROM Document REF JOIN WrittenBy REF JOIN Author

WHERE publication_date.year=2003 AND

address.state=‘WA’

As such, the expression “Document REF JOIN WrittenBy REF JOIN Author” is an example of a reference join 240 of the subject invention, wherein an SQL Server's Transactional SQL (TSQL) language can be extended therewith, to enable navigation over relationships defined by referential constraints. Thus, a simpler query syntax and semantics is supplied to express multi-table join navigation over primary key/foreign key, for example.

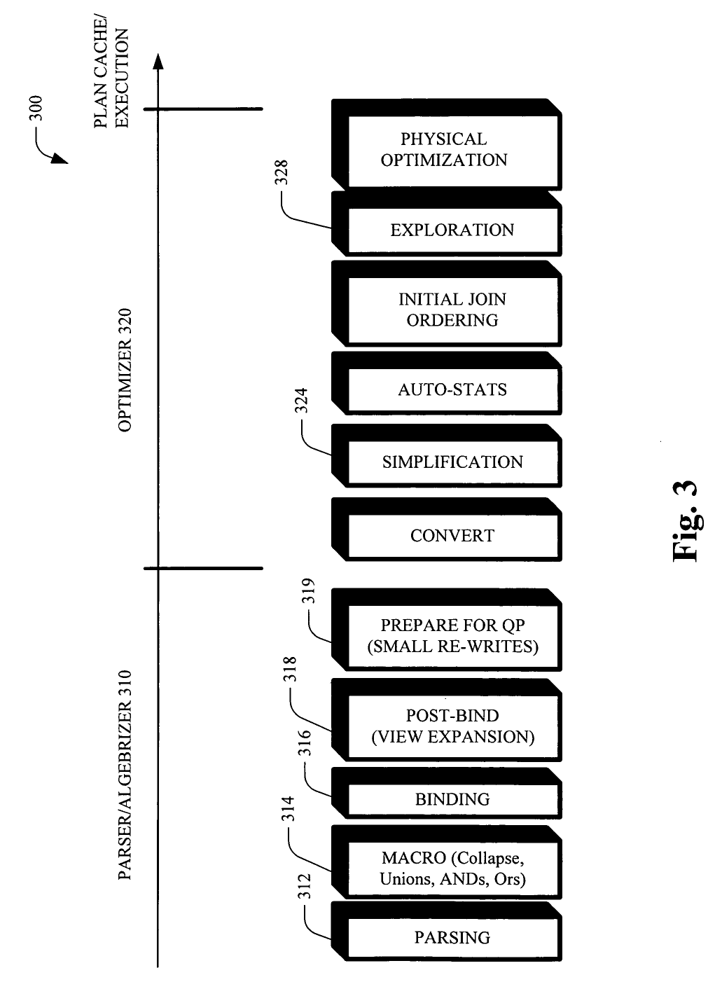

FIG. 3 illustrates a block diagram of a Query Compilation Pipeline 300 that can implement various aspects of the subject invention. The query compilation pipeline 300 employs a plurality of components to facilitate the compilation of a SQL statement into an executable query plan. Typically such SQL Server query compilation 300 can be divided into two major sections, namely an parser/algebrizer segment 310, and an optimizer segment 320. In general, the parser/algebrizer part 310 is responsible for translating a SQL statement into an equivalent relational algebra tree. Likewise, the optimizer segment 320 can search a space of equivalent query plans, to find efficient ways to return results to the user, wherein such process can result in a physical execution plan.

As illustrated in FIG. 3, a parsing component 312 can take a textual representation of a SQL statement, and divide such statement into fundamental components (e.g, tokens), and verify that the statement conforms to the SQL language grammar rules. The output of the parsing component 312 can be a relational operator (RelOp) tree. Likewise, the macro component 314 can perform simple re-writes to transform binary RelOp trees containing nodes with union operators and scalar expressions involving ANDs and Ors into equivalent n-ary trees.

Similarly, the binding component 316 can validate that a syntactically correct SQL statement refers to objects that actually exist in the system. For example, in the following query, the binding component can validate that MyTable exists and that col1 and col2 exist in MyTable.

SELECT Col1, col2 FROM MyTable

As such, the binding component 316 can reference System Metadata, to determine existence of such objects.

As illustrated in FIG. 3, the post-bind component 318 associated with the parser/algebrizer segment 310 can be responsible for expanding views into a query tree. Accordingly, a user query can reference a plurality of views, wherein all such views can be expanded, to form a single query tree representing the complete operation. In general, views can facilitate modeling abstraction, as complex logic can be isolated for use in multiple places, and/or complexities of the data model representation can be hidden. Moreover, the PrepareForQP component 319 can transform a correctly bound RelOp tree, to a logical operator (LogOp) tree that supplies a suitable input to the query optimizer segment 320.

As part of the optimizer segment 320, a Simplification component 324 can perform a number of re-writes of the query tree created by the parser/algebrizer segment 310. For example, filters can be re-written to push them towards the leaves of the tree to facilitate later index matching. Other kinds of simplifications are performed to normalize the tree for efficient processing and to perform optimizations that are known to be feasible without cost-based trade-offs. Similarly, an Exploration component 328 of the optimizer segment 320 can consider a large number of alternatives to find the most efficient execution strategy. Such can be performed by employing a cost-based framework that makes trade-offs about the execution time of various strategies based on data distribution, memory, disk usage, and the like.

In general, SQL Server supports querying multiple machines through an associated Distributed/Heterogeneous Query component. The functionality in accordance with the invention can be implemented with few extensions to the existing framework. For example, queries over remote sources are also represented as relational algebra trees, and binding can be performed such that remote metadata is queried to validate schema of referenced objects. Additionally, statistics and index metadata can be queried during the optimization phase performed by the optimizer segment 320, as part of the plan search. During the exploration phase, query tree fragments can also be translated into SQL queries to be sent to the remote source.

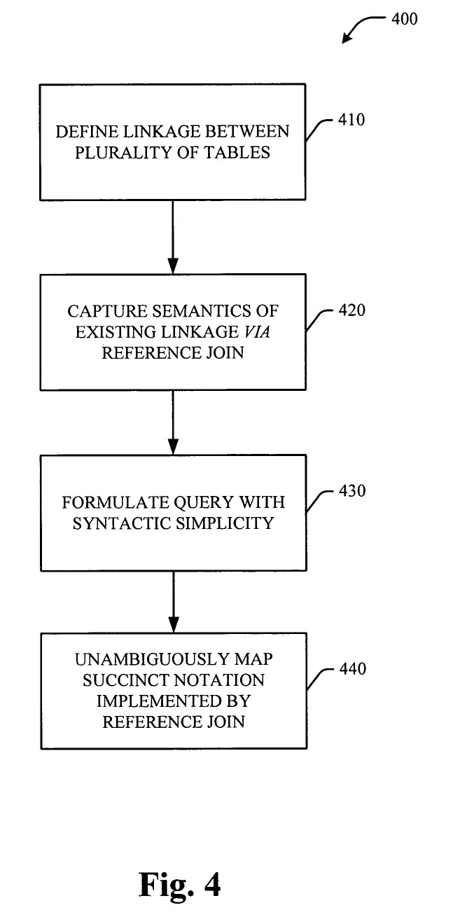

Referring now to FIG. 4, a methodology 400 of simplifying a formulation of joins via a REF join in accordance with an aspect of the subject invention is illustrated. While the exemplary method is illustrated and described herein as a series of blocks representative of various events and/or acts, the present invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the present invention. Moreover, it will be appreciated that the exemplary method and other methods according to the invention may be implemented in association with the method illustrated and described herein, as well as in association with other systems and apparatus not illustrated or described.

Initially and at 410, a linkage between a plurality of tables can be defined via SQL data definition statements (DDL) in accordance with implementations of a relational item store. Next and at 420, by exploiting the knowledge of existing relationships in a data base (e.g., primary key-foreign key relationships captured in relational metadata), the reference join of the subject invention can capture semantics of the existing linkage. Accordingly, a query statement can be formulated with syntactic simplicity, at 430. For example, to supply a reference join in accordance with the invention between a two source tables (e.g., a left_table_source {LTS} and a right _table _source {RTS}), in general only one referential constraint should typically exist between the tables. As such, the reference join can be employed, when a SQL compiler unambiguously maps succinct notation implemented by the reference join, wherein typically only one path exists among relationship, at 440.

Thus, the SQL compiler can employ existing knowledge about referential constraints to enable an unambiguous transformation of the reference join (REF JOIN) expression into the equivalent INNER JOIN on the columns involved in such referential constraints between the two tables. Accordingly, a simpler query syntax and semantics can be provided to express multi-table join navigation over primary key/foreign key.

In a related aspect, the reference joins of the subject invention can be table expressions defined in the FROM clause of a SQL SELECT statement. An exemplary syntax can be in form of:

<query specification> ::=
SELECT [ ALL | DISTINCT ]

[TOP expression [PERCENT] [ WITH TIES ] ]
< select_list >
[ INTO new_table ]
[ FROM { <table_source> } [ ,...n ] ]
[ WHERE <search_condition> ]
[ GROUP BY [ ALL ] group_by_expression [ ,...n ]
[ WITH { CUBE | ROLLUP } ]
]
[ HAVING < search_condition > ]

[ FROM { <table_source> } [ ,...n ] ]
<table_source> ::=
{

table_name [ [ AS ] table_alias ] [ <

tablesample_clause > ]

[ WITH ( < table_hint > [ ,...n ] ) ]

| view_name [ [ AS ] table_alias ] [ WITH ( < view_hint

> [ ,...n ] ) ]

| rowset_function [ [ AS ] table_alias ]

[ ( bulk_column_alias [ ,...n ] ) ]

| user_defined_function [ [ AS ] table_alias ]
| OPENXML <openxml_clause>
| derived_table [ AS ] table_alias [ ( column_alias [

,...n ] ) ]

| <joined_table>
| <pivoted_table>
| <unpivoted_table>

}
<tablesample_clause> ::=

TABLESAMPLE [SYSTEM] (sample_number [ PERCENT |
ROWS ]

)

[ REPEATABLE (repeat_seed) ]

<joined_table> ::=
{

<table_source> <join_type> <table_source> ON

<search_condition>

| <table_source> CROSS JOIN <table_source>
| <left_table_source> REF JOIN <right_table_source>
| left_table_source { CROSS | OUTER } APPLY

right_table_source

| [ ( ] <joined_table> [ ) ]

}
< join_type> ::=

[ { INNER | { { LEFT | RIGHT | FULL }
[ OUTER ] } } [

<join_hint> ] ]

JOIN

<pivoted_table> ::=

table_source PIVOT <pivot_clause> table_alias

<pivot_clause> ::=

( aggregate_function ( value_column )

FOR pivot_column
IN ( <column_list>)

)

<unpivoted_table> ::=

table_source UNPIVOT <unpivot_clause> table_alias

<unpivot_clause> ::=

( value_column FOR pivot_column IN ( <column_list> ) )

<column_list> ::=

column_name [, ...]

Typically, one-to-one and one-to-many relationships are usually modeled by direct referential constraints between the two tables at each side of the relationship. For example, for the two tables of “Employee” and “Department” with a many-to-one relationship (fk_dep) between them, the model can include:

CREATE Employee (

| E_id INT PRIMARY KEY, | |
|---|---|
| D_id | INT REFERENCES Department ( d_id ), |

Name NVARCHAR(100),
...

CONSTRAINT fk_dep FOREIGN KEY e_id REFERENCES
Department
(d_id) -- models N:1 relationship
)
CREATE Department (

| D_id INT PRIMARY KEY, | |
|---|---|
| Mgr_id | INT REFERENCES Employee ( e_id ) |

Name NVARCHAR(50),
...

)

Likewise, many-to-many relationships can in general be modeled by introduction of an intermediate table (e.g., a relationship table) between the two tables at each side of the relationship. For example, there can be an N:M (N, M being an integer) relationship between the “Document” and “Author” tables, wherein the table “WrittenBy” captures such relationship. Similarly, a second N:M relationship can exist between “Document” and “Author” captured by the “ReviewedBy” table.

CREATE TABLE Document (

| D_id INT PRIMARY KEY, | |
|---|---|
| Title | NVARCHAR(250), |

| | |
|---|---|
| Publication_date | DATETIME, |

Type NVARCHAR(10)

)
CREATE TABLE Author (

| A_id INT PRIMARY KEY, | |
|---|---|
| Name NVARCHAR(100), | |
| Dep_id | INT, |
| Address | ADDRESS |

)
CREATE TABLE WrittenBy (

D_id INT REFERENCES Document ( d_id ),
A_id INT REFERENCES Author ( a_id ),

CONSTRAINT fk_doc FOREIGN KEY d_id REFERENCES
Document
(d_id), -- models 1:N relationship
CONSTRAINT fk_aut FOREIGN KEY a_id REFERENCES
Author (a_id)
-- models 1:N relationship
)
CREATE TABLE ReviewedBy (

D_id INT REFERENCES Document ( d_id ),
A_id INT REFERENCES Author ( a_id ),

CONSTRAINT fk_rev_doc FOREIGN KEY d_id REFERENCES
Document
(d_id) , -- models 1:N relationship
CONSTRAINT fk_rev_aut FOREIGN KEY a_id REFERENCES
Author
(a_id) -- models 1:N relationship
)

As explained earlier, for the REF JOIN expression to be valid there typically should exist one and only one referential constraint between the <left_table_source>(LTS) and the <righ_table_source>(RTS). If such condition is met, the expression:
<LTS>REF JOIN<RTS> can be transformed by the parser/algebrizer, to an equivalent expression of the form:
<LTS>INNER JOIN<RTS> ON LTS.col1=RTS.col1 AND . . . AND LTS.col_n=RTS.col_n.

In addition, all columns of LTS and RTS are in the scope (e.g., visible) of the query expression, similar to an equivalent inner join expression.

Accordingly, an explicit reference join path in accordance with an aspect of the subject invention enables navigation of multi-table N:M relationships unambiguously, as the notation can explicitly denote the relationship the user wishes to navigate. For example, the REF JOIN expressions:

Document REF JOIN WrittenBy REF JOIN Author

Document REF JOIN ReviewedBy REF JOIN Author

can represent two different relationship navigation expressions.

In a related aspect of implicit reference join paths, reference joins of the subject invention can be transformed to inner joins, wherein if there is an unambiguous referential integrity constraint path between a plurality of tables, then some tables can remain unexposed, and provide for table “hops” during navigation. For example, once there is an unambiguous referential integrity constraint path between Table 1 (T1) and Table 2 (T2) via Table 3 (T3), then T1 REF JOIN T2 can translate into T1 INNER JOIN T3 INNER JOIN T2, without exposing columns of T3. In the previous Document and Author example, if there exists a single relationship between these two entities, such as the WrittenBy relationship, a user can employ the following statement to find all authors of the document:

Document REF JOIN Author

As such, referring to the Document and Author example described in detail supra, if there exists only one N:M relationships between Document and Author, (e.g., the WrittenBy relationship), then the expression Document REF JOIN Author can be automatically translated by the parser/algebrizer into an equivalent expression of “Document INNER JOIN WrittenBy INNER JOIN Author”, without typically a need to mention the WrittenBy table reference.

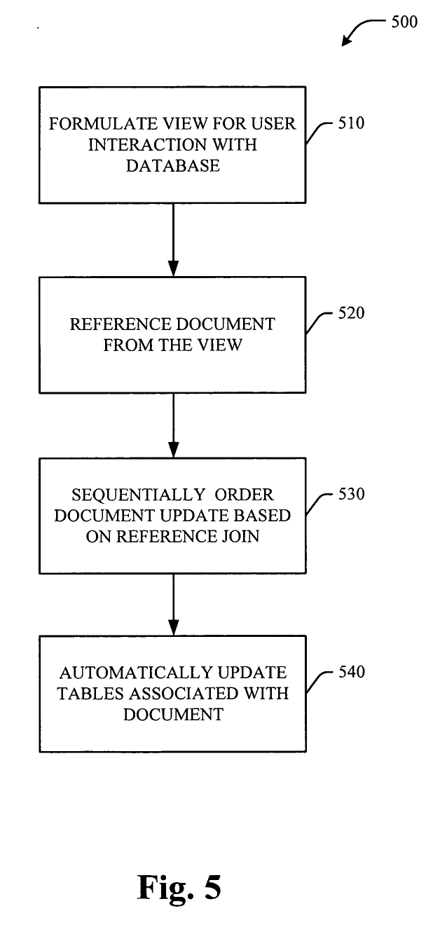

FIG. 5 illustrates an exemplary methodology 500 of view update with reference joins, according to a particular aspect of the invention. Initially and at 510, views can be formulated for a user's interaction with the database. Typically, users can reference document views to obtain required values, and during an update the reference joins can facilitate automatic transformation of corresponding primitive updates on the underlying base tables, to execute the base table update in proper order to satisfy referential integrity constraints. Subsequently at 520, a document in the database can be referenced via such view, and provide for a symmetric system. The REF joins of the subject invention can facilitate an automatic translation of insert, delete, and updates of object views as defined by such REF JOINs. Such automatic translation into the corresponding “ordered” sequence of equivalent base table updates, can be performed at 530 by respecting the referential integrity constraints that are defined among the underlying base tables, which contribute to the view. Thus at 540, knowledge of the system enables an automatic ordered update of the tables associated with the view.

Likewise, to insert an object that is mapped into multiple tables, the object insert can be transformed into a set of inserts into the underlying tables. As explained earlier, such set of inserts should typically be performed in a proper and specific order to preserve the referential integrity constraints. For example, an object view “DocAuthor” that represents Documents and their Authors via the “WrittenBy” relationship, can map an insert into the Documents, Authors, and then WrittenBy tables, respectively. Such order can be determined by exploiting the dependency graph.

Similarly, definition of the constraint in the reference join can be employed to delete an object. As such, a delete can occur from the root of a dependency graph (or the root can be implicitly located from the object view mapping model described in “insert”), wherein an ON DELETE CASCADE for all FK constraints can be employed to remove the complete object.

Moreover, an update to an object can occur via a whole update of the object by generating a set of deletes followed by a set of inserts across all tables involved. Alternatively or in conjunction, updates can occur over portions of the object, wherein default behavior in SQL Server supplies the ability to update the many side of the N:1 join chain (where N is an integer). In the object view approach, an unambiguous reference can be supplied for the column from any of the participating tables in the REF JOIN. Such can mitigate a proper order requirement in the underlying tables.

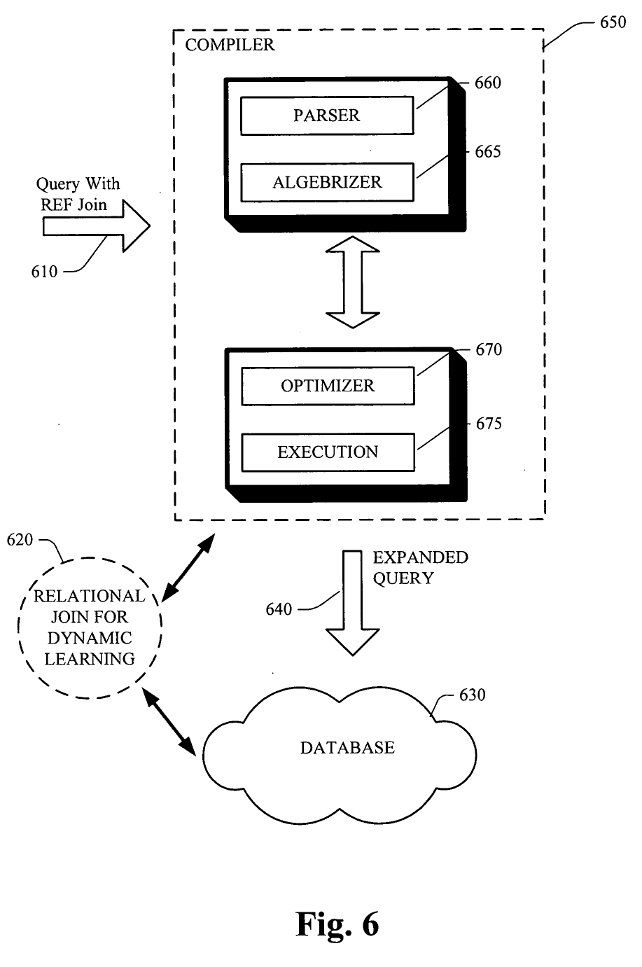

FIG. 6 illustrates a block diagram of a relational join 620 that can dynamically learn the linkage constrains among tables, as the database 630 grows. As illustrated in FIG. 6, a query 610 that implements a reference join (REF JOIIN) is being forwarded to a compiler 650 for transformation to an equivalent expanded syntax 640, in accordance with an aspect of the subject invention. Such query 610 with reference join can exploit existing relationships in the data base 630 to formulate a syntactic simplicity.

In general, the parser component 660 and the algebrizer component 665 can be responsible for translating a SQL statement with reference join into an equivalent relational algebra tree. For example, the parser component 660 can take a textual representation of a SQL statement, and divide such statement into fundamental components (e,g, tokens), and verify that the statement conforms to the SQL language grammar rules. Likewise, the optimizer component 670 can search a space of equivalent query plans, to find efficient ways to return results to the user, wherein such process can result in a physical execution plan, by the execution component 675. At the same time, the relational join component 620 can dynamically learn the various relationships created—as compared to the static existing foreign key (FK)-primary key (PK) relationship. Accordingly, as the database 630 grows, the relational join component 620 can guide the compiler to spell out the reference join employed in the Query 610.

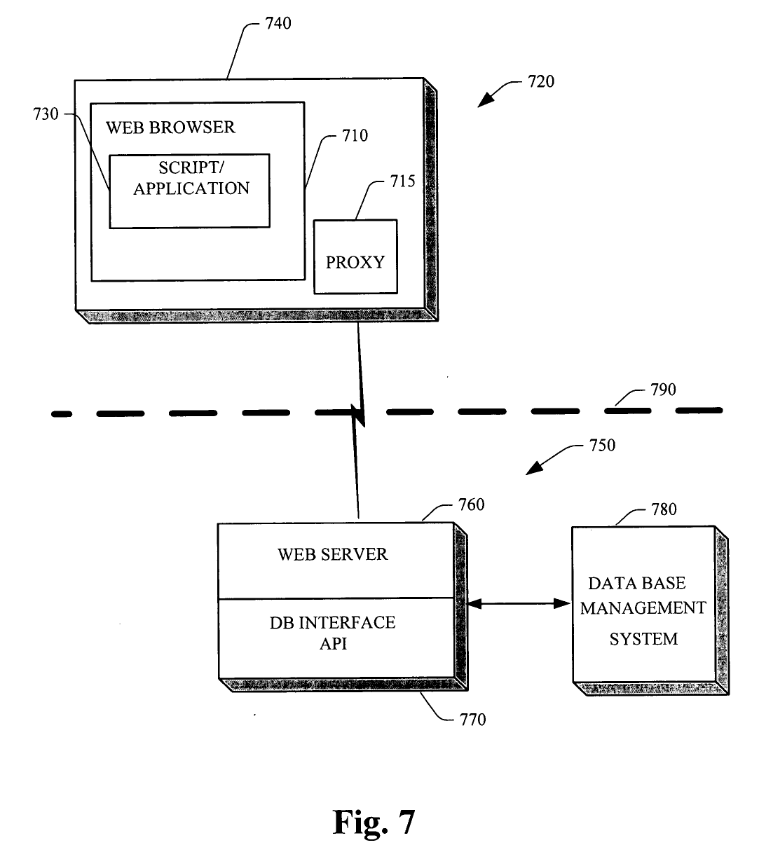

FIG. 7 illustrates a client-server arrangement that can employ a reference join as part of a query language according to an aspect of the invention, wherein running on the client 720 is a client process, for example, a web browser 710. Likewise, running on the server 750 is a corresponding server process, for example, a web server 760. In addition, embedded in the Web Browser 710 can be a script or application 730, and running within the run-time environment 740 of the client computer 720, can exist a proxy 715 for packaging and unpacking data packets formatted in accordance with various aspects of the invention. Communicating with the server 750 is a database management system (DBMS) 780, which manages access to a database (not shown). The DBMS 780 and the database (not shown) can be located in the server itself, or can be located remotely on a remote database server (not shown). Running on the Web server 760 is a database interface Applications Programming Interface (API) 770, which provides access to the DBMS 780. The client computer 720 and the server computer 750 can communicate with each other through a network 790. When the client process, e.g., the Web browser 710, requests data from a database, the script or application 730 issues a query, which is sent across the network (e.g. internet) 790 to the server computer 750, where it is interpreted by the server process, e.g., the Web server 760. The client's 720 request to server 750 can contain multiple commands, and a response from server 750 can return a plurality of result sets. Responses to client commands that are returned can be self-describing, and record oriented; (e.g. the data streams can describe names, types and optional descriptions of rows being returned.)

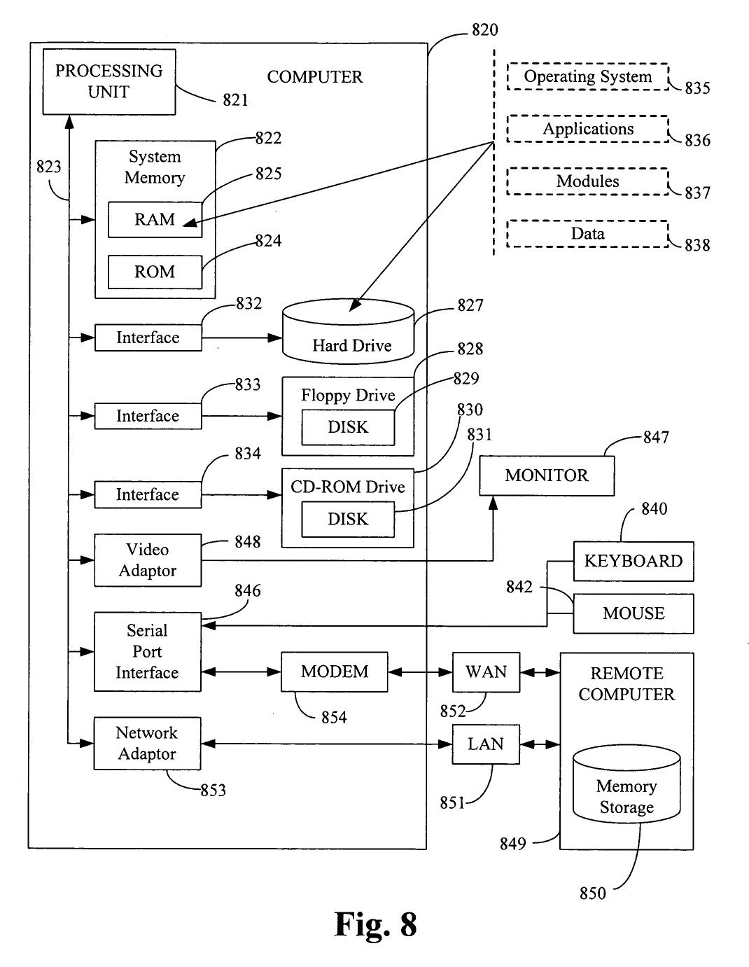

Referring now to FIG. 8, a brief, general description of a suitable computing environment is illustrated wherein the various aspects of the subject invention can be implemented. While the invention has been described above in the general context of computer-executable instructions of a computer program that runs on a computer and/or computers, those skilled in the art will recognize that the invention can also be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like. As explained earlier, the illustrated aspects of the invention can also be practiced in distributed computing environments where tasks are performed by remote processing devices that are linked through a communications network. However, some, if not all aspects of the invention can be practiced on stand-alone computers. In a distributed computing environment, program modules can be located in both local and remote memory storage devices. The exemplary environment includes a computer 820, including a processing unit 821, a system memory 822, and a system bus 823 that couples various system components including the system memory to the processing unit 821. The processing unit 821 can be any of various commercially available processors. Dual microprocessors and other multi-processor architectures also can be used as the processing unit 821.

The system bus can be any of several types of bus structure including a USB, 1394, a peripheral bus, and a local bus using any of a variety of commercially available bus architectures. The system memory may include read only memory (ROM) 824 and random access memory (RAM) 825. A basic input/output system (BIOS), containing the basic routines that help to transfer information between elements within the computer 820, such as during start-up, is stored in ROM 824.

The computer 820 further includes a hard disk drive 827, a magnetic disk drive 828, e.g., to read from or write to a removable disk 829, and an optical disk drive 830, e.g., for reading from or writing to a CD-ROM disk 831 or to read from or write to other optical media. The hard disk drive 827, magnetic disk drive 828, and optical disk drive 830 are connected to the system bus 823 by a hard disk drive interface 832, a magnetic disk drive interface 833, and an optical drive interface 834, respectively. The drives and their associated computer-readable media provide nonvolatile storage of data, data structures, computer-executable instructions, etc. for the computer 820. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, can also be used in the exemplary operating environment, and further that any such media may contain computer-executable instructions for performing the methods of the subject invention.

A number of program modules can be stored in the drives and RAM 825, including an operating system 835, one or more application programs 836, other program modules 837, and program data 838. The operating system 835 in the illustrated computer can be substantially any commercially available operating system.

A user can enter commands and information into the computer 820 through a keyboard 840 and a pointing device, such as a mouse 842. Other input devices (not shown) can include a microphone, a joystick, a game pad, a satellite dish, a scanner, or the like. These and other input devices are often connected to the processing unit 821 through a serial port interface 846 that is coupled to the system bus, but may be connected by other interfaces, such as a parallel port, a game port or a universal serial bus (USB). A monitor 847 or other type of display device is also connected to the system bus 823 via an interface, such as a video adapter 848. In addition to the monitor, computers typically include other peripheral output devices (not shown), such as speakers and printers.

The computer 820 can operate in a networked environment using logical connections to one or more remote computers, such as a remote computer 849. The remote computer 849 may be a workstation, a server computer, a router, a peer device or other common network node, and typically includes many or all of the elements described relative to the computer 820, although only a memory storage device 850 is illustrated in FIG. 8. The logical connections depicted in FIG. 8 may include a local area network (LAN) 851 and a wide area network (WAN) 852. Such networking environments are commonplace in offices, enterprise-wide computer networks, Intranets and the Internet.

When employed in a LAN networking environment, the computer 820 can be connected to the local network 851 through a network interface or adapter 853. When utilized in a WAN networking environment, the computer 820 generally can include a modem 854, and/or is connected to a communications server on the LAN, and/or has other means for establishing communications over the wide area network 852, such as the Internet. The modem 854, which can be internal or external, can be connected to the system bus 823 via the serial port interface 846. In a networked environment, program modules depicted relative to the computer 820, or portions thereof, can be stored in the remote memory storage device. It will be appreciated that the network connections shown are exemplary and other means of establishing a communications link between the computers can be employed.

In accordance with the practices of persons skilled in the art of computer programming, the subject invention has been described with reference to acts and symbolic representations of operations that are performed by a computer, such as the computer 820, unless otherwise indicated. Such acts and operations are sometimes referred to as being computer-executed. It will be appreciated that the acts and symbolically represented operations include the manipulation by the processing unit 821 of electrical signals representing data bits which causes a resulting transformation or reduction of the electrical signal representation, and the maintenance of data bits at memory locations in the memory system (including the system memory 822, hard drive 827, floppy disks 829, and CD-ROM 831) to thereby reconfigure or otherwise alter the computer system's operation, as well as other processing of signals. The memory locations wherein such data bits are maintained are physical locations that have particular electrical, magnetic, or optical properties corresponding to the data bits.

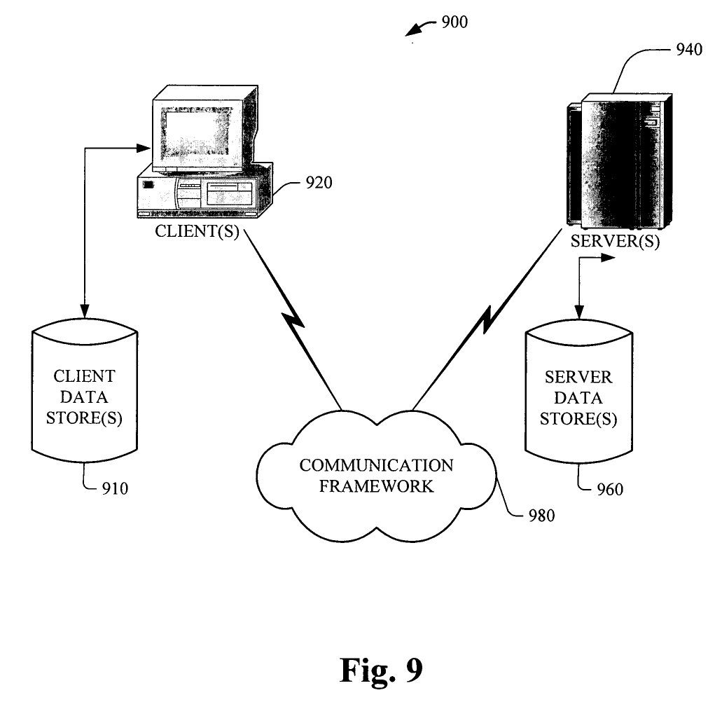

Referring now to FIG. 9, a client-server system 900 that can employ a reference join according to one aspect of the invention is illustrated. The client(s) 920 can be hardware and/or software (e.g., threads, processes, computing devices). The system 900 also includes one or more server(s) 940. The server(s) 940 can also be hardware and/or software (e.g., threads, processes, computing devices). For example, such servers 940 can house threads to perform transformations by employing the invention. The client 920 and the server 940 can communicate, between two or more computer processes. As illustrated, the system 900 includes a communication framework 980 that can facilitate communications between the client(s) 920 and the server(s) 940. The client(s) 920 is operationally connected to one or more client data store(s) 910 that can store information local to the client(s) 920. Moreover, client 920 can access and update databases 960 located on a server computer 940 running a server process. In one aspect of the invention, the communication frame work 980 can be the internet, with the client process being a Web browser and the server process being a Web server. As such, a typical client 920 can be a general purpose computer, such as a conventional personal computer having a central processing unit (CPU), system memory a modem or network card for connecting the personal computer to the Internet, and a display as well as other components such as a keyboard, mouse, and the like. Likewise a typical server 940 can be university or corporate mainframe computers, or dedicated workstations, and the like.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention. Furthermore, to the extent that the terms “includes”, “including”, “has”, “having”, and variants thereof are used in either the detailed description or the claims, these terms are intended to be inclusive in a manner similar to the term “comprising.”

What is claimed is:

1. A system that facilitates database querying, comprising:
a compiler that receives a query for interaction with a database; and
a relational join component that extends a corresponding query language via a reference join(s) to capture semantics of an existing linkage among plurality of tables associated with the database, to reduce syntax required to explore or navigate therethrough.

2. The system of claim 1, the existing linkage includes primary key-foreign key relationships captured in relational metadata.

3. The system of claim 2, the reference join supplied between a left table source and a right table source with one referential constraint existing therebetween.

4. The system of claim 3, the one referential constraint includes an unambiguous transformation for an expression of the reference join into equivalent inner joins of associated columns.

5. The system of claim 1, the compiler transforms the reference join to inner joins, and provides for table hops during navigation of the database.

6. The system of claim 1, the compiler unambiguously maps succinct notations implemented by the reference join, if only one path exists among relationships.

7. The system of claim 1 further comprising a further relational join component that dynamically learns various relationships created in the database.

8. The system of claim 1 further comprising document views that are referenced by a user to obtain required values, and for execution of base table update in proper order to satisfy referential integrity constraints.

9. The system of claim 1, the compiler further comprises a parser/algebrizer that transforms Structured Query Language (SQL) for the reference join into an equivalent relational algebra tree.

10. The system of claim 9, the compiler further comprises an optimizer that searches a space for an equivalent query plan for the reference join.

11. The system of claim 10 further comprising a simplification component that performs re-writes of query tree created by the parser/algebrizer.

12. A method of simplifying database querying comprising:
defining linkage according to item store implementations among tables associated with a database;
extending a query language via a reference join to capture semantics of the linkage, and reduce syntax required to explore or navigate the database; and
formulating the query language with syntactic simplicity of the reference join.

13. The method of claim 12 further comprising unambiguously mapping succinct notations implemented by the reference join via only one path that exists among relationships.

14. The method of claim 13 further comprising employing existing knowledge about referential constraints to unambiguously transform an expression of the reference join into an equivalent inner join on columns that are involved in the referential constraints between tables.

15. The method of claim 14 further comprising employing a constraint in the reference join, to delete an object.

16. The method of claim 12 further comprising formulating a view for a user's interaction with the database.

17. The method of claim 16 further comprising transforming an object insert to a set of inserts, and into underlying tables.

18. The method of claim 17 further comprising transforming corresponding primitive updates on underlying base tables, to execute base table update in an order that satisfies referential integrity constraints.

19. The method of claim 18 further comprising updating an object as a whole or over portions thereof.

20. A system that facilitates database querying, comprising:
means for compiling a query that interacts with a database; and
means for extending a corresponding query language to capture semantics of existing linkage among plurality of tables associated with the database, to reduce syntax required to explore or navigate therethrough.
